(19) United States
(12) Patent Application Publication
(10) Pub. No.: US 2024/0396614 A1
(43) Pub. Date: Nov. 28, 2024

(54) METHODS AND APPARTUS OF MONITORING PDCCH SCHEDULING COMMON INFORMATION WITH MULTIPLE TRP TRANSMISSION

(71) Applicant: Lenovo (Beijing) Limited, Beijing (CN)

(72) Inventors: Yi Zhang, Beijing (CN); Chenxi Zhu, Beijing (CN); Bingchao Liu, Beijing (CN); Wei Ling, Beijing (CN); Lingling Xiao, Beijing (CN)

(73) Assignee: Lenovo (Beijing) Limited, Beijing (CN)

(21) Appl. No.: 18/576,622

(22) PCT Filed: Jul. 9, 2021
(86) PCT No.: PCT/CN2021/105461

§ 371 Date: Jan. 4, 2024

(51) Int. Cl. H04B 7/06; H04W 72/23

(52) U.S. Cl. CPC H04B 7/06968; H04W 72/23

(57) ABSTRACT

Methods and apparatus of monitoring PDCCH scheduling common information with multiple TRP transmission are disclosed. The method includes: receiving, by a receiver, a signaling indicating that one or two Transmission Configuration Indication (TCI) states are activated for a Control Resource Set (CORESET) with index zero for transmission of Physical Downlink Control Channel (PDCCH) with common control information on PDCCH candidates; determining, by a processor, a monitoring occasion and a Quasi Co-Location (QCL) based on at least one of the activated TCI states and a predefined association relationship between Synchronization Signal Block (SSB) indexes and PDCCH monitor occasions; and performing, by the processor, a blind detection for the PDCCH with common control information on the determined monitoring occasion based on the determined QCL.

### FIELD

The subject matter disclosed herein relates generally to wireless communication and more particularly relates to, but not limited to, methods and apparatus of monitoring Physical Downlink Control Channel (PDCCH) scheduling common information with multiple Transmission and Reception Point (TRP) transmission.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Entity/Equipment (UE), Network Equipment (NE), Radio Access Technology (RAT), Receive or Receiver (RX), Transmit or Transmitter (TX), Physical Downlink Control Channel (PDCCH), Physical Downlink Shared Channel (PDSCH), Physical Random Access Channel (PRACH), Physical Broadcast Channel (PBCH), Enhanced Physical Downlink Control Channel (ePDCCH), Bandwidth Part (BWP), Control Element (CE), Control Resource Set (CORESET), Channel State Information (CSI), Channel State Information Reference Signal (CSI-RS), Common Search Space (CSS), Downlink Control Information (DCI), Frequency Division Multiple Access (FDMA), Identifier (ID), Logical Channel ID, or Logical Channel Index (LCID), Media Access Control (MAC), Master Information Block (MIB), Radio Network Temporary Identifier (RNTI), Radio Resource Control (RRC), Media Access Control-Control Element (MAC CE), Subcarrier Spacing (SCS), Single Frequency Network (SFN), System Frame Number (SFN), System Information Block (SIB), Synchronization Signal Block (SSB), Transmission and Reception Point (TRP), Cell Radio Network Temporary Identifier (C-RNTI), Frequency Range 1 (FR1), Frequency Range 2 (FR2), Transmission Configuration Indication (TCI), Tracking Reference Signal (TRS), Technical Specification (TS), Quasi Co-Location (QCL), Search Space (SS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP. A TRP may also be referred to as a transmitting-receiving identity, or simply an identity.

In current NR system, Physical Downlink Control Channel (PDCCH) is transmitted from a single TRP. With multiple TRPs, time-frequency resources for PDCCH transmission may be from multiple TRPs. The spatial diversity may be exploited in addition to the time-frequency diversity. Enhanced Physical Downlink Control Channel (ePDCCH) can be transmitted with multiple repetition from multiple TRPs to improve PDCCH transmission reliability and robustness. Multiple transmissions of the ePDCCH may be transmitted from a same TRP or some different TRPs.

### SUMMARY

Methods and apparatus of monitoring PDCCH scheduling common information with multiple TRP transmission are disclosed.

According to a first aspect, there is provided a method, including: receiving, by a receiver, a signaling indicating that one or two Transmission Configuration Indication (TCI) states are activated for a Control Resource Set (CORESET) with index zero for transmission of Physical Downlink Control Channel (PDCCH) with common control information on PDCCH candidates; determining, by a processor, a monitoring occasion and a Quasi Co-Location (QCL) based on at least one of the activated TCI states and a predefined association relationship between Synchronization Signal Block (SSB) indexes and PDCCH monitor occasions; and performing, by the processor, a blind detection for the PDCCH with common control information on the determined monitoring occasion based on the determined QCL.

According to a second aspect, there is provided a method, including: transmitting, by a transmitter, a signaling indicating that one or two Transmission Configuration Indication (TCI) states are activated for a Control Resource Set (CORESET) with index zero for transmission of Physical Downlink Control Channel (PDCCH) with common control information on PDCCH candidates; determining, by a processor, a monitoring occasion and a Quasi Co-Location (QCL) based on at least one of the activated TCI states and a predefined association relationship between Synchronization Signal Block (SSB) indexes and PDCCH monitor occasions; and transmitting, by the transmitter, the PDCCH with common control information on the determined monitoring occasion based on the determined QCL.

According to a third aspect, there is provided an apparatus, including: a receiver that receives a signaling indicating that one or two Transmission Configuration Indication (TCI) states are activated for a Control Resource Set (CORESET) with index zero for transmission of Physical Downlink Control Channel (PDCCH) with common control information on PDCCH candidates; and a processor that determines a monitoring occasion and a Quasi Co-Location (QCL) based on at least one of the activated TCI states and a predefined association relationship between Synchronization Signal Block (SSB) indexes and PDCCH monitor occasions; wherein the processor performs a blind detection for the PDCCH with common control information on the determined monitoring occasion based on the determined QCL.

According to a fourth aspect, there is provided an apparatus, including: a transmitter that transmits a signaling indicating that one or two Transmission Configuration Indication (TCI) states are activated for a Control Resource Set (CORESET) with index zero for transmission of Physical Downlink Control Channel (PDCCH) with common control information on PDCCH candidates; and a processor that determines a monitoring occasion and a Quasi Co-Location (QCL) based on at least one of the activated TCI states and a predefined association relationship between Synchronization Signal Block (SSB) indexes and PDCCH monitor occasions; wherein the transmitter further transmits the PDCCH with common control information on the determined monitoring occasion based on the determined QCL.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of TCI state indication for UE-specific PDCCH MAC CE in accordance with some implementations of the present disclosure;

FIG. 5 is a schematic diagram illustrating an example of determination of monitoring occasion based on TCI state indicated by MAC CE for CORESET #0 in accordance with some implementations of the present disclosure;

FIG. 6 is a schematic diagram illustrating an example of TCI state indication for PDCCH MAC CE in accordance with some implementations of the present disclosure;

FIG. 7 is a flow chart illustrating steps of monitoring PDCCH scheduling common information with multiple TRP transmission by UE in accordance with some implementations of the present disclosure; and

FIG. 8 is a flow chart illustrating steps of monitoring PDCCH scheduling common information with multiple TRP transmission by gNB or NE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more” unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

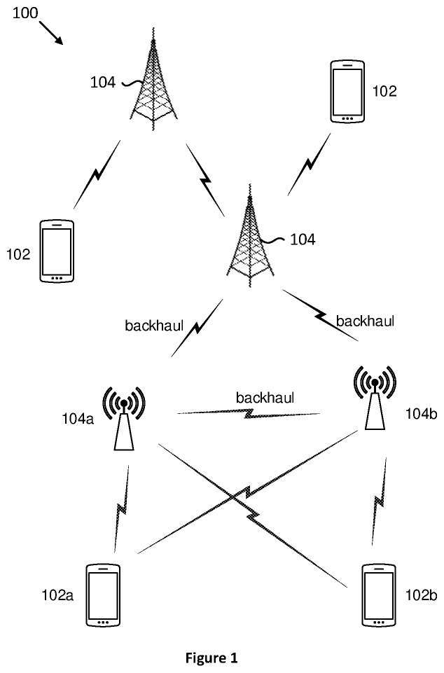

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

The technology disclosed, or at least some of the examples, may be applicable to scenarios with multiple TRPs or without multiple TRPs, as long as multiple PDCCH transmissions are supported.

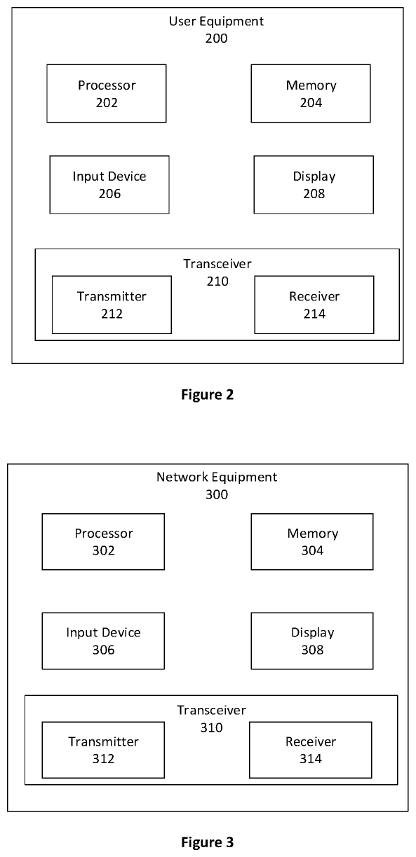

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

For common control information, such as SIB1, other system information, paging, etc., UE monitors PDCCH candidates in Type0-PDCCH CSS (common search space) set, Type0A-PDCCH CSS set, Type2-PDCCH CSS set, respectively.

For RRC idle state, the UE monitors Type0-PDCCH CSS set on the PDCCH monitoring occasions as described in section 13 of TS 38.213, where the association relationship between an SSB index and PDCCH monitoring occasions is defined. This association may also be referred to as “default association” in the disclosure.

For CONNECTED state, if Type0/0A/2-PDCCH CSS is SS #0, i.e., Type0/0A/2-PDCCH CSS set having searchSpaceID value of zero (0), the UE monitors the common search space on the PDCCH monitoring occasions determined based on the default association, where the SSB is the one quasi-co-located (QCLed) to the CSI-RS/TRS in the TCI-state indicated for CORESET #0, or the SSB is the one selected through the random access procedure with a PRACH transmission not initiated by a PDCCH order that triggers a non-contention based random access procedure.

The UE monitoring behavior for Type0/0A/2-PDCCH CSS set with searchSpaceID of “0” is specified in section 10.1 of TS 38.213. The detailed information is as follows.

If a UE is provided a zero value for searchSpaceID in PDCCH-ConfigCommon for a Type0/0A/2-PDCCH CSS set, the UE determines monitoring occasions for PDCCH candidates of the Type0/0A/2-PDCCH CSS set as described in Clause 13, and the UE is provided a C-RNTI, the UE monitors PDCCH candidates only at monitoring occasions associated with a SS/PBCH block, where the SS/PBCH block is determined by the most recent of
a MAC CE activation command indicating a TCI state of the active BWP that includes a CORESET with index 0, as described in [6, TS 38.214], where the TCI-state includes a CSI-RS which is quasi-co-located with the SS/PBCH block, or
a random access procedure that is not initiated by a PDCCH order that triggers a contention-free random access procedure.

For UE monitoring Type0-PDCCH CSS set, the association between an SSB index and PDCCH monitoring occasions is defined in Table 13-11, Table 13-12, Table 13-13, Table 13-14, and Table 13-15 in section 13 of TS 38.213. The detailed information is as follows.

If during cell search a UE determines from MIB that a CORESET for Type0-PDCCH CSS set is present, as described in Clause 4.1, the UE determines a number of consecutive resource blocks and a number of consecutive symbols for the CORESET of the Type0-PDCCH CSS set from controlResourceSetZero in pdcch-ConfigSIB1, as described in Tables 13-1 through 13-10, for operation without shared spectrum channel access, or as described in Tables 13-1A and 13-4A for operation with shared spectrum channel access, and determines PDCCH monitoring occasions from searchSpaceZero in pdcch-ConfigSIB1, included in MIB, as described in Tables 13-11 through 13-15. SFN_{C} and n_{C} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot n_{SSB,i}. The symbols of the CORESET associated with pdcch-ConfigSIB1 in MIB or with searchSpaceSIB1 in PDCCH-ConfigCommon have normal cyclic prefix.

For operation without shared spectrum channel access and for the SS/PBCH block and CORESET multiplexing pattern 1, a UE monitors PDCCH in the Type0-PDCCH CSS set over two consecutive slots starting from slot n₀. For SS/PBCH block with index i, the UE determines an index of slot n₀ as n₀=(O·2^{μ}+└i·M┘)mod Nₛₗₒₜ^{frame,μ} that is in a frame with system frame number (SFN) SFN_{C} satisfying SFN_{C} mod 2=0 if └(O·2^{μ}+└i·M┘)/Nₛₗₒₜ^{frame,μ}┘ mod 2=0, or in a frame with SFN satisfying SFN_{C} mod 2=1 if └(O·2^{μ}+└i·M┘)/Nₛₗₒₜ^{frame,μ}┘ mod 2=1. M and O are provided by Tables 13-11 and 13-12, and μ∈{0, 1, 2, 3} based on the SCS for PDCCH receptions in the CORESET [4, TS 38.211]. The index for the first symbol of the CORESET in slots n₀ and n₀+1 is the first symbol index provided by Tables 13-11 and 13-12.

For the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For the SS/PBCH block and CORESET multiplexing patterns 2 and 3, if the active DL BWP is the initial DL BWP, the UE is expected to be able to perform radio link monitoring, as described in Clause 5, and measurements for radio resource management [10, TS 38.133] using a SS/PBCH block that provides a CORESET for Type0-PDCCH CSS set. For a SS/PBCH block with index i, the UE determines the slot index n_{C} and SFN_{C} based on parameters provided by Tables 13-13 through 13-15.

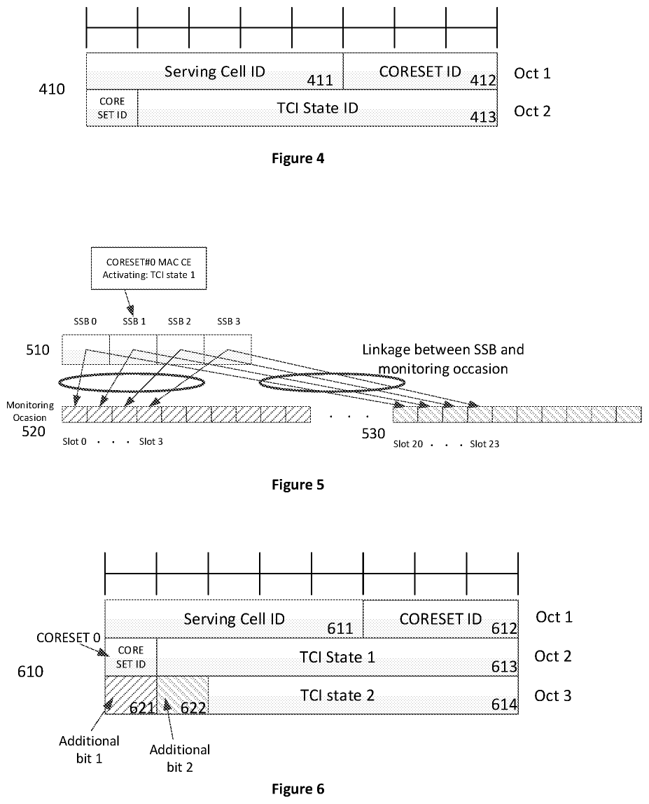

The MAC CE activation command for indicating a TCI state is specified in TS 38.321. The detailed information is illustrated as follows with reference to FIG. 4, which is an example of TCI state indication for UE-specific PDCCH MAC CE in accordance with some implementations of the present disclosure.

The TCI State Indication for UE-specific PDCCH MAC CE 410 is identified by a MAC subheader with LCID. It has a fixed size of 16 bits with following fields:
Serving Cell ID 411: This field indicates the identity of the Serving Cell for which the MAC CE applies. The length of the field is 5 bits. If the indicated Serving Cell is configured as part of a simultaneousTCI-UpdateList1-r16 or simultaneousTCI-UpdateList2-r16 as specified in TS 38.331, this MAC CE applies to all the Serving Cells in the set simultaneousTCI-UpdateList1-r16 or simultaneousTCI-UpdateList2-r16, respectively;
CORESET ID 412: This field indicates a Control Resource Set identified with ControlResourceSetId as specified in TS 38.331, for which the TCI State is being indicated. In case the value of the field is 0, the field refers to the Control Resource Set configured by controlResourceSetZero as specified in TS 38.331. The length of the field is 4 bits;
TCI State ID 413: This field indicates the TCI state identified by TCI-StateId as specified in TS 38.331 applicable to the Control Resource Set identified by CORESET ID field. If the field of CORESET ID is set to 0, this field indicates a TCI-StateId for a TCI state of the first 64 TCI-states configured by tci-States-ToAddModList and tci-States-ToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

Based on PDCCH monitoring behavior defined in Release 15, UE only monitors occasions associated with SSB QCLed to the one TCI state indicated for CORESET #0, i.e., the CORESET with index zero.

For easy reference, PDCCH scheduling common information, e.g., SIB, paging may also be referred to as “common PDCCH” in the disclosure.

In the conventional scheme defined in Release 15, for CONNECTED state, if Type0/0A/2-PDCCH CSS is SS #0, the UE monitors the common search space on the PDCCH monitoring occasions determined based on the one activated TCI state and the default association, where the SSB can be the one QCLed to the CSI-RS/TRS in the TCI-state indicated for the CORESET #0.

FIG. 5 illustrates an example of determination of monitoring occasion based on TCI state indicated by MAC CE for CORESET #0 in accordance with some implementations of the present disclosure. In this example, TCI state 1 is indicated for CORESET #0 by MAC CE; and monitoring occasions 0-3 (520) in slot 0 to slot 3 are associated with SSB 0-3 (510), respectively. The linkage, or predefined association relationship, between SSB indexes and PDCCH monitoring occasions is a one-to-one mapping, as indicated by arrows from the SSB 510 to monitoring occasions 520. Similar linkage exists between the SSB 510 and the monitoring occasions 530 starting from slot 20. The monitoring occasions, e.g., slot 1, 21, etc. may be selected for monitoring common PDCCH based on the default association and QCL information from indicated TCI state 1 for CORESET #0. In the conventional scheme defined in Release 15, only one TCI state (e.g., TCI state 1) is indicated for CORESET #0 and one corresponding occasion is used for monitoring.

However, for PDCCH transmission for high speed train scenario, two TCI states may be activated for UE specific PDCCH transmission from CORESET #0.

For PDCCH transmission for high speed train scenario, repeated PDCCHs may be transmitted from multiple CORESETs from multiple TRPs and one search space set is associated with one CORESET. Specifying which TCI state from two activated TCI states to determine monitoring occasion in SS #0 for Type 0/0A/2-PDCCH CSS and determining QCL for monitoring PDCCH scheduling common information is required.

CORESET #0 may be used for PDCCH transmission for both common control information and UE specific control information, e.g., DCI for fallback scheduling. According to the current agreement in RANI #104 e-Meeting, two TCI states may be activated by enhanced MAC CE signaling for SFN-based PDCCH transmission. The corresponding MAC CE includes at least the following fields: Serving cell ID, CORESET ID, and Two TCI state IDs. Thus, schemes for determining monitoring occasions and QCL in view of two activated TCI states are desired. In detail, it is required to determine which TCI state(s) is or are used to determine monitoring occasions and to serve as QCL information for monitoring common PDCCH.

In the disclosure, the association between SSB and monitoring occasion as specified in TS 38.213 in Release 15 for Type0-PDCCH CSS may be reused to determine monitoring occasion for CORESET #0.

In the disclosure, both implicit and explicit schemes for determining monitoring occasions and QCL are proposed to determine monitoring occasions and Quasi Co-Location (QCL) for monitoring common PDCCH where one or two TCI states may be activated for CORESET #0.

### Implicit Schemes for Determining Monitoring Occasions and OCL

The monitoring occasion for common PDCCH is associated with SSB determined by TCI state indicated by MAC CE for CORESET #0 (i.e., CORESET with index zero). The linkage between SSB and monitoring occasion is a one-to-one mapping. Thus, when two TCI states are activated for CORESET #0, it is required to determine which TCI state is used to determine monitoring occasion and QCL. Three schemes are proposed.

In a first scheme, one of the two activated TCI states, e.g., the first activated TCI state, may be used for determining monitoring occasions.

This scheme is proposed based on two different assumptions on common PDCCH transmission.

The first assumption is that a single TCI state is used for common PDCCH transmission. The common PDCCH may be transmitted from one TRP or multiple TRPs with Release 15 SFN-based transmission scheme. This is a basic transmission scheme which is supported by Release 15 or Release 16 specification since common PDCCH is received by multiple UEs. Based on this assumption, the TCI state corresponding to the link between the TRP transmitting common control information and UE is used to determine monitoring occasion, where the default association between SSB and monitoring occasion may be reused. For simplicity, in an example, the first activated TCI state may be used to determine monitoring occasion. In some examples, the first activated TCI state may be selected based on a predefined rule. For the candidate TCI states activated by MAC CE, there is the same restriction as Release15 that a UE is expected to be configured only with the TCI state of CSI-RS/TRS QCLed with an SSB; and the determination of QCL aligns with common PDCCH transmission. Thus, the selected activated TCI state, e.g., the first activated TCI state, is used to determine QCL; and the UE only monitors PDCCH candidates based on the first indicated TCI state information for common PDCCH.

Based on the first assumption, in this scheme, the PDCCH monitoring occasions are determined based on the first activated TCI state and the default association which is a predefined association between SSB and monitoring occasion for search space (SS) #0. The QCL is determined based on the first activated TCI state. The UE monitors PDCCH candidates based on the first TCI state for common PDCCH.

The second assumption is that two TCI states are used for common PDCCH transmission. The common PDCCH can be transmitted explicitly from two TRPs simultaneously. This is an enhanced transmission scheme for common PDCCH which is not supported by Release 15 or Release 16 specification, and is discussed in Release 17. This enhanced transmission scheme is designed for specific UE or group of UEs with the same desirable beam pair from two TRPs. With SFN-based transmission, the reliability for common PDCCH transmission is improved. In the enhanced SFN-based transmission scheme, two TCI states activated by MAC CE can be used for both common PDCCH and UE specific PDCCH from CORESET #0. Based on this assumption, one monitoring occasion has to be determined by two activated TCI states on account of simultaneous common PDCCH transmission from both TRPs.

One of the two activated TCI states may be selected for determining monitoring occasions. One simple scheme is to use a first activated TCI state to determine monitoring occasions. For the selected TCI state, there is the same restriction as Release 15 that a UE is expected to be configured only with the TCI state of CSI-RS/TRS QCLed with an SSB. Both activated TCI states may be used to determine QCL. The UE monitors PDCCH candidates based on information of both indicated TCI states for common PDCCH.

Based on the second assumption, in this scheme, the PDCCH monitoring occasion is determined based on the first activated TCI state and the default association between SSB and monitoring occasion for search space #0. The QCL is determined based on the two activated TCI states. The UE monitors PDCCH candidates based on the both indicated TCI states for common PDCCH.

In a second scheme for determining monitoring occasions and QCL, the UE is not expected that two TCI states are activated for CORESET #0.

In this scheme, restriction for MAC CE signaling is introduced. Specifically, only one TCI state may be activated for CORESET #0. Because of the introduction of this restriction, the monitoring behavior defined in Release15 for common PDCCH may be reused. It is the simplest scheme and has the smallest standard impact. However, this scheme is not able to support SFN PDCCH transmission for both UE specific and common PDCCH from CORESET #0, and thus, it cannot further improve reliability relative to Release 15 or Release 16 PDCCH transmission.

In a third scheme, PDCCH monitoring occasion and QCL assumption is not changed when two activated TCI states are indicated for CORESET #0.

In this scheme, only UE specific PDCCH transmission with two TCI states is supported and common PDCCH transmission with two activated TCI states is not supported. When two TCI states are activated for CORESET #0, the information of the two activated TCI states is used for UE specific PDCCH monitoring. For common PDCCH, the UE ignores the TCI state indication with two activated states. The UE assumes that there is no change in monitoring occasion and QCL assumption, and determines the monitoring occasion and the QCL according to previously determined monitoring occasion and QCL. If gNB wants to change monitoring occasion and QCL information, it has to use MAC CE activating signaling for CORESET #0 with only one TCI state. In comparison with the second scheme where it is not expected that two TCI states are activated for CORESET #0, this scheme achieves better performance for UE specific PDCCH since it supports enhanced SFN based transmission.

According to this scheme, the UE, upon receiving the signaling indicating that two TCI states are activated for the CORESET with index zero, determines the monitoring occasion and the QCL according to previously determined monitoring occasion and QCL.

### Explicit Schemes for Determining Monitoring Occasions and OCL

Based on the above discussion, UE monitoring behavior may be related with the following information:
1. Whether one TCI state or two TCI states from two activated TCI states for CORESET #0 are used to determine monitoring occasion and QCL; and
2. Which TCI state(s) is or are used to determine monitoring occasion and QCL if two TCI states are activated by MAC CE.

Two signaling bits may be introduced in MAC CE to indicate the above information.

A one-bit additional signaling may be introduced to indicate whether one TCI state or two TCI states from the two activated TCI states are used for determining monitoring occasion and QCL for common PDCCH. For example, ‘0’ may denote that only one activated TCI state is used, and ‘1’ denotes that both activated TCI states are used; or vice versa. With this newly introduced signaling, the flexible switching for common PDCCH transmission with single or multiple activated TCI states may be supported. In one application scenario, for example, UE 1 and UE 3 both have the capability to support receiving PDCCH transmission with two activated TCI states, but UE 2 does not have this capability. For UE 1, two activated TCI states can be used for UE specific PDCCH receiving. However, only one activated TCI state may be used for common PDCCH receiving when common PDCCH is received by UE 1 and UE 2 simultaneously; and two TCI states may be used for common PDCCH receiving when common PDCCH is received by UE 1 and UE 3 simultaneously.

Optionally, another one-bit additional signaling may be used to indicate which TCI state is used to determine PDCCH monitoring occasion. For example, ‘0’ may denote that the first activated TCI state is used to determine monitoring occasion, and ‘1’ may denote that the second activated TCI state is used to determine monitoring occasion; and vice versa. With this newly introduced signaling, it provides some flexibility to select channel with good quality for receiving common control information.

That is, a signaling bit may be used for indicating that, where two TCI states are activated for the CORESET with index zero, one or two of the activated TCI states are used for determining the monitoring occasion and the QCL for the blind detection of the PDCCH with common control information; and/or another signaling bit may be used for indicating a selected one of the two TCI states for determining the monitoring occasion.

The detailed signaling may be designed as shown in FIG. 6, which illustrates an example of TCI state indication for PDCCH MAC CE in accordance with some implementations of the present disclosure. Two additional bits 1 and 2 (621, 622 in FIG. 6) are introduced in the MAC CE 610 as shown in FIG. 6. For example, additional bit 1 (621) may be used to indicate whether one or two TCI states from the two activated TCI states are used for determining monitoring occasion and QCL for common PDCCH; and additional bit 2 (622) may be used to indicate which TCI state is used to determine PDCCH monitoring occasion. For TCI state indication for CORESETs except CORESET with zero index (i.e., CORESET ID is zero), it is designed with 7 bits for indicating one TCI state from 128 TCI states. For CORESET 0, the TCI state field (e.g., 613 or 614) indicates a TCI-StateId for a TCI state of the first 64 TCI-states configured by tci-States-ToAddModList and tci-States-ToReleaseList in the PDSCH-Config in the active BWP. Thus, only 6 bits are required for TCI state indication 614 for CORESET 0. For PDCCH MAC CE indicating two TCI states for CORESET 0, two additional bits 621, 622 and 6 bits for TCI indication 614 may be used. For other CORESETs, 1 bit such as additional bit 1 (621) in FIG. 6 is reserved and the other 7 bits in Oct 3 are used for the second TCI state indication.

As shown in FIG. 6, when two TCI states are activated for the CORESET with index zero, the PDCCH MAC CE for TCI state indication for CORESET with zero index has a size of 24 bits with the following fields: 5 bits of Serving Cell ID 611; 4 bits of CORESET ID (‘0’); 7 bits of TCI State 1 613; 1 bit 621 used for indication described above; 1 bit 622 used for indication described above; and 6 bits of TCI State 2 614. The TCI State 2 614 uses one bit less than the TCI State 1 613.

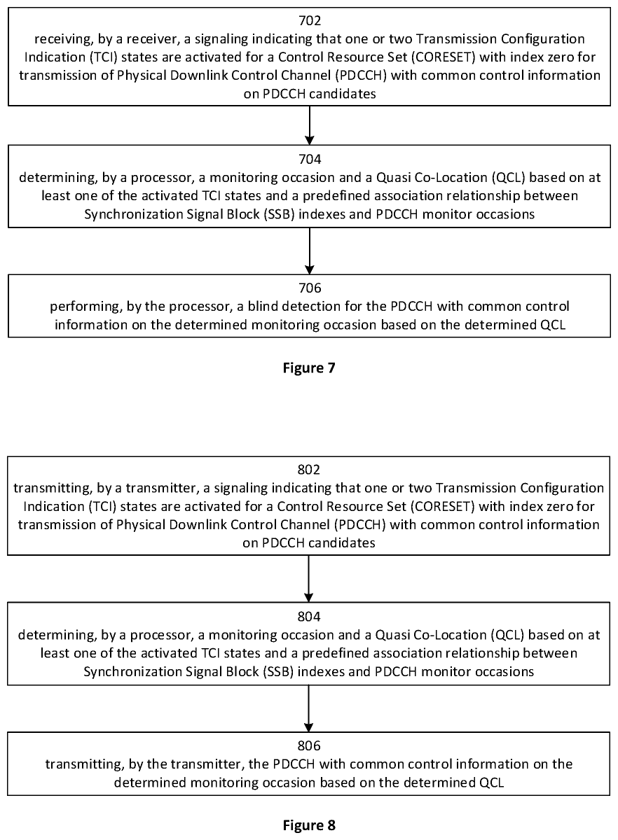

FIG. 7 is a flow chart illustrating steps of monitoring PDCCH scheduling common information with multiple TRP transmission by UE 200 in accordance with some implementations of the present disclosure.

At step 702, the receiver 214 of UE 200 receives a signaling indicating that one or two Transmission Configuration Indication (TCI) states are activated for a Control Resource Set (CORESET) with index zero for transmission of Physical Downlink Control Channel (PDCCH) with common control information on PDCCH candidates.

At step 704, the processor 202 of UE 200 determines a monitoring occasion and a Quasi Co-Location (QCL) based on at least one of the activated TCI states and a predefined association relationship between Synchronization Signal Block (SSB) indexes and PDCCH monitor occasions.

At step 706, the processor 202 of UE 200 performs a blind detection for the PDCCH with common control information on the determined monitoring occasion based on the determined QCL.

FIG. 8 is a flow chart illustrating steps of monitoring PDCCH scheduling common information with multiple TRP transmission by gNB or NE 300 in accordance with some implementations of the present disclosure.

At step 802, the transmitter 312 of NE 300 transmits a signaling indicating that one or two Transmission Configuration Indication (TCI) states are activated for a Control Resource Set (CORESET) with index zero for transmission of Physical Downlink Control Channel (PDCCH) with common control information on PDCCH candidates.

At step 804, the processor 302 of NE 300 determines a monitoring occasion and a Quasi Co-Location (QCL) based on at least one of the activated TCI states and a predefined association relationship between Synchronization Signal Block (SSB) indexes and PDCCH monitor occasions.

At step 806, the transmitter 312 of NE 300 transmits the PDCCH with common control information on the determined monitoring occasion based on the determined QCL.

In one aspect, some items as examples of the disclosure concerning a method of a UE or remote device may be summarized as follows:
1. A method, comprising:
receiving, by a receiver, a signaling indicating that one or two Transmission Configuration Indication (TCI) states are activated for a Control Resource Set (CORESET) with index zero for transmission of Physical Downlink Control Channel (PDCCH) with common control information on PDCCH candidates;
determining, by a processor, a monitoring occasion and a Quasi Co-Location (QCL) based on at least one of the activated TCI states and a predefined association relationship between Synchronization Signal Block (SSB) indexes and PDCCH monitor occasions; and
performing, by the processor, a blind detection for the PDCCH with common control information on the determined monitoring occasion based on the determined QCL.
2. The method of item 1, wherein the monitoring occasion is determined based on a first one of the activated TCI states.
3. The method of item 1 wherein the QCL is determined based on the first indicated TCI state.
4. The method of item 1, wherein the QCL is determined based on the two indicated TCI states.
5. The method of item 1, wherein it is not expected that two TCI states are activated for the CORESET with index zero.
6. The method of item 1, wherein, upon receiving the signaling indicating that two TCI states are activated for the CORESET with index zero, the monitoring occasion and the QCL are determined according to previously determined monitoring occasion and QCL.
7. The method of item 1, wherein the receiver further receives a signaling bit for indicating that, where two TCI states are activated for the CORESET with index zero, one or two of the activated TCI states are used for determining the monitoring occasion and the QCL for the blind detection of the PDCCH with common control information.
8. The method of item 7, wherein the receiver further receives a signaling bit for indicating a selected one of the two TCI states for determining the monitoring occasion.
9. The method of item 7 or 8, wherein two TCI states are activated for the CORESET with index zero; and the receiver further receives a Media Access Control-Control Element (MAC CE) that comprises a first TCI state indication and a second TCI state indication; the second TCI state indication uses one bit less than the first TCI state indication; and the one bit not used by the second TCI state indication is reused as the signaling bit.

In another aspect, some items as examples of the disclosure concerning a method of a NE or gNB may be summarized as follows:
10. A method, comprising:
transmitting, by a transmitter, a signaling indicating that one or two Transmission Configuration Indication (TCI) states are activated for a Control Resource Set (CORESET) with index zero for transmission of Physical Downlink Control Channel (PDCCH) with common control information on PDCCH candidates;
determining, by a processor, a monitoring occasion and a Quasi Co-Location (QCL) based on at least one of the activated TCI states and a predefined association relationship between Synchronization Signal Block (SSB) indexes and PDCCH monitor occasions; and
transmitting, by the transmitter, the PDCCH with common control information on the determined monitoring occasion based on the determined QCL.
11. The method of item 10, wherein the monitoring occasion is determined based on a first one of the activated TCI states.
12. The method of item 10, wherein the QCL is determined based on the first indicated TCI state.
13. The method of item 10, wherein the QCL is determined based on the two indicated TCI states.
14. The method of item 10, wherein it is not expected that two TCI states are activated for the CORESET with index zero.
15. The method of item 10, wherein, upon transmitting the signaling indicating that two TCI states are activated for the CORESET with index zero, it is expected that the monitoring occasion and the QCL are determined according to previously determined monitoring occasion and QCL.
16. The method of item 10, the transmitter further transmits a signaling bit for indicating that, where two TCI states are activated for the CORESET with index zero, one or two of the activated TCI states are used for determining the monitoring occasion and the QCL for the blind detection of the PDCCH with common control information.
17. The method of item 16, wherein the transmitter further transmits a signaling bit for indicating a selected one of the two TCI states for determining the monitoring occasion.
18. The method of item 16 or 17, wherein two TCI states are activated for the CORESET with index zero; and the transmitter further transmits a Media Access Control-Control Element (MAC CE) that comprises a first TCI state indication and a second TCI state indication; the second TCI state indication uses one bit less than the first TCI state indication; and the one bit not used by the second TCI state indication is reused as the signaling bit.

In a further aspect, some items as examples of the disclosure concerning a UE or remote device may be summarized as follows:
19. An apparatus, comprising:
a receiver that receives a signaling indicating that one or two Transmission Configuration Indication (TCI) states are activated for a Control Resource Set (CORESET) with index zero for transmission of Physical Downlink Control Channel (PDCCH) with common control information on PDCCH candidates; and
a processor that determines a monitoring occasion and a Quasi Co-Location (QCL) based on at least one of the activated TCI states and a predefined association relationship between Synchronization Signal Block (SSB) indexes and PDCCH monitor occasions;
wherein the processor performs a blind detection for the PDCCH with common control information on the determined monitoring occasion based on the determined QCL.
20. The apparatus of item 19, wherein the monitoring occasion is determined based on a first one of the activated TCI states.
21. The apparatus of item 19, wherein the QCL is determined based on the first indicated TCI state.
22. The apparatus of item 19, wherein the QCL is determined based on the two indicated TCI states.
23. The apparatus of item 19, wherein it is not expected that two TCI states are activated for the CORESET with index zero.
24. The apparatus of item 19, wherein, upon receiving the signaling indicating that two TCI states are activated for the CORESET with index zero, the monitoring occasion and the QCL are determined according to previously determined monitoring occasion and QCL.
25. The apparatus of item 19, wherein the receiver further receives a signaling bit for indicating that, where two TCI states are activated for the CORESET with index zero, one or two of the activated TCI states are used for determining the monitoring occasion and the QCL for the blind detection of the PDCCH with common control information.
26. The apparatus of item 25, wherein the receiver further receives a signaling bit for indicating a selected one of the two TCI states for determining the monitoring occasion.
27. The apparatus of item 25 or 26, wherein two TCI states are activated for the CORESET with index zero; and the receiver further receives a Media Access Control-Control Element (MAC CE) that comprises a first TCI state indication and a second TCI state indication; the second TCI state indication uses one bit less than the first TCI state indication; and the one bit not used by the second TCI state indication is reused as the signaling bit.

In a yet further aspect, some items as examples of the disclosure concerning a NE or gNB may be summarized as follows:
28. An apparatus, comprising:
a transmitter that transmits a signaling indicating that one or two Transmission Configuration Indication (TCI) states are activated for a Control Resource Set (CORESET) with index zero for transmission of Physical Downlink Control Channel (PDCCH) with common control information on PDCCH candidates; and
a processor that determines a monitoring occasion and a Quasi Co-Location (QCL) based on at least one of the activated TCI states and a predefined association relationship between Synchronization Signal Block (SSB) indexes and PDCCH monitor occasions;
wherein the transmitter further transmits the PDCCH with common control information on the determined monitoring occasion based on the determined QCL.
29. The apparatus of item 28, wherein the monitoring occasion is determined based on a first one of the activated TCI states.
30. The apparatus of item 28, wherein the QCL is determined based on the first indicated TCI state.
31. The apparatus of item 28, wherein the QCL is determined based on the two indicated TCI states.
32. The apparatus of item 28, wherein it is not expected that two TCI states are activated for the CORESET with index zero.
33. The apparatus of item 28, wherein, upon transmitting the signaling indicating that two TCI states are activated for the CORESET with index zero, it is expected that the monitoring occasion and the QCL are determined according to previously determined monitoring occasion and QCL.
34. The apparatus of item 28, the transmitter further transmits a signaling bit for indicating that, where two TCI states are activated for the CORESET with index zero, one or two of the activated TCI states are used for determining the monitoring occasion and the QCL for the blind detection of the PDCCH with common control information.
35. The apparatus of item 34, wherein the transmitter further transmits a signaling bit for indicating a selected one of the two TCI states for determining the monitoring occasion.
36. The apparatus of item 34 or 35, wherein two TCI states are activated for the CORESET with index zero; and the transmitter further transmits a Media Access Control-Control Element (MAC CE) that comprises a first TCI state indication and a second TCI state indication; the second TCI state indication uses one bit less than the first TCI state indication; and the one bit not used by the second TCI state indication is reused as the signaling bit.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a signaling indicating that one or more Transmission Configuration Indication (TCI) states are activated for a Control Resource Set (CORESET) with index zero for transmission of Physical Downlink Control Channel (PDCCH) with common control information on PDCCH candidates;
determine a monitoring occasion and a Quasi Co-Location (QCL) based on at least one of the activated TCI states and a predefined association relationship between Synchronization Signal Block (SSB) indexes and PDCCH monitor occasions; and
perform a blind detection for the PDCCH with common control information on the determined monitoring occasion based on the determined QCL.

2. The UE of claim 1, wherein the at least one processor is configured to cause to UE to determine the monitoring occasion based on a first one of the activated TCI states.

3. The UE of claim 1, wherein the at least one processor is configured to cause the UE to determine the QCL based on a first indicated TCI state.

4. The UE of claim 1, wherein the at least one processor is configured to cause the UE to determine the QCL based on two indicated TCI states.

5. The UE of claim 1, wherein two TCI states are not activated for the CORESET with index zero.

6. The UE of claim 1, wherein the at least one processor is configured to cause the UE to determine, based at least in part on the signaling indicating that two TCI states are activated for the CORESET with index zero, the monitoring occasion and the QCL according to previously determined monitoring occasion and QCL.

7. The UE of claim 1, wherein the at least one processor is configured to cause the UE to receive a first signaling bit for indicating that, where one or more TCI states are activated for the CORESET with index zero, one or more of the activated TCI states are used for determining the monitoring occasion and the QCL for the blind detection of the PDCCH with common control information.

8. The UE of claim 7, wherein the at least one processor is configured to cause the UE to receive a second signaling bit for indicating a selected one of the two TCI states for determining the monitoring occasion.

9. The UE of claim 7, wherein two TCI states are activated for the CORESET with index zero; and the at least one processor is configured to cause the UE to receive a Media Access Control-Control Element (MAC CE) that comprises a first TCI state indication and a second TCI state indication; the second TCI state indication uses one bit less than the first TCI state indication; and the one bit not used by the second TCI state indication is reused as one or more of the first signaling bit or the second signaling bit.

10. A network equipment (NE) for wireless communication, comprising:
at least one memory; and
at least one processor coupled with the at least one memory and configured to cause the NE to:
transmit a signaling indicating that one or more Transmission Configuration Indication (TCI) states are activated for a Control Resource Set (CORESET) with index zero for transmission of Physical Downlink Control Channel (PDCCH) with common control information on PDCCH candidates;
determine a monitoring occasion and a Quasi Co-Location (QCL) based on at least one of the activated TCI states and a predefined association relationship between Synchronization Signal Block (SSB) indexes and PDCCH monitor occasions; and
transmit the PDCCH with common control information on the determined monitoring occasion based on the determined QCL.

11. The NE of claim 10, wherein the at least one processor is configured to cause the NE to determine the monitoring occasion based on a first one of the activated TCI states.

12. The NE of claim 10, wherein the at least one processor is configured to cause the NE to determine the QCL based on a first indicated TCI state.

13. The NE of claim 10, wherein the at least one processor is configured to cause the NE to determine the QCL based on two indicated TCI states.

14. The NE of claim 10, wherein two TCI states are not to be activated for the CORESET with index zero.

15. The NE of claim 10, wherein the at least one processor is configured to cause the NE to transmit signaling indicating that one or more TCI states are activated for the CORESET with index zero, and determine the monitoring occasion and the QCL according to previously determined monitoring occasion and QCL.

16. A processor for wireless communication, comprising:
at least one controller coupled with at least one memory and configured to cause the processor to:
receive a signaling indicating that one or more Transmission Configuration Indication (TCI) states are activated for a Control Resource Set (CORESET) with index zero for transmission of Physical Downlink Control Channel (PDCCH) with common control information on PDCCH candidates;
determine a monitoring occasion and a Quasi Co-Location (QCL) based on at least one of the activated TCI states and a predefined association relationship between Synchronization Signal Block (SSB) indexes and PDCCH monitor occasions; and
perform a blind detection for the PDCCH with common control information on the determined monitoring occasion based on the determined QCL.

17. The processor of claim 16, wherein the at least one controller is configured to cause the processor to determine the monitoring occasion based on a first one of the activated TCI states.

18. The processor of claim 16, wherein the at least one controller is configured to cause the processor to determine the QCL based on a first indicated TCI state.

19. The processor of claim 16, wherein the at least one controller is configured to cause the processor to determine the QCL based on two indicated TCI states.

20. The processor of claim 16, wherein two TCI states are not activated for the CORESET with index zero.
